(19) United States
(12) Patent Application Publication
(10) Pub. No.: US 2017/0337110 A1
(43) Pub. Date: Nov. 23, 2017

(54) DATA PROCESSING DEVICE

(71) Applicant: MITSUBISHI ELECTRIC CORPORATION, Tokyo (JP)

(72) Inventor: Akiko YONETA, Tokyo (JP)

(73) Assignee: MITSUBISHI ELECTRIC CORPORATION, Tokyo (JP)

(21) Appl. No.: 15/522,097

(22) PCT Filed: Jan. 14, 2015
(86) PCT No.: PCT/JP2015/000127

§ 371 Date: Apr. 26, 2017

(51) Int. Cl. G06F 11/18; G06F 11/20

(52) U.S. Cl. CPC G06F 11/182; G06F 11/2023

(57) ABSTRACT

The present invention provides a data processing device that includes a memory and includes a first CPU and a second CPU, each having an instruction processing section to process an instruction, a cache to store part of data of the memory, an error detection section to detect an error in the data stored in the cache, and an error correction section to correct the data stored in the cache on the basis of the data stored in the cache and an error notification and output corrected data to the instruction processing section, wherein the error correction section of the first CPU receives, as input, the data stored in the cache of the first CPU, the error notification of the first CPU, the data stored in the cache of the second CPU, and the second error notification, and if the error notification of the first CPU is an error and the error notification of the second CPU is not an error, outputs the data stored in the cache of the second CPU to the instruction processing section of the first CPU, and in other cases, outputs the data stored in the cache of the first CPU to the instruction processing section of the first CPU.

### TECHNICAL FIELD

The present invention relates to a data processing device that can detect a fault.

### BACKGROUND ART

As a method for enhancing the reliability of a data processing device, there is lockstep according to which CPUs (Central Processing Units) are arranged in a redundant configuration and the outputs of both of the CPUs are compared so as to detect a fault. In typical lockstep, the outputs of two CPUs are compared while the two CPUs execute the same program, and a fault is detected if a mismatch occurs.

However, it is not possible to determine which of the CPUs has caused the fault only by comparing the outputs of the two CPUs, and thus processing cannot be continued. If CPUs are arranged in triplicate or more, it is possible to select a normal output by majority decision, but hardware cost is increased.

Patent Literature 1 proposes a method according to which an element provided with fault detection means is included in elements of a redundant configuration, and if a fault is detected in a given element, the output of an element in which no fault is detected is selected and output.

In Patent Literature 2, if a fault in an internal RAM (Random Access Memory) of a CPU operating in lockstep is detected within the CPU, a mismatch output by a comparator for CPU outputs is inhibited and a failure in the internal RAM is remedied, thereby enhancing the reliability of a system.

Patent Literature 3 describes a method according to which when a comparison error occurs in duplicate systems and an abnormality is detected in one of the systems, data in a storage device of the system in which no abnormality has been detected is transferred to a storage device of the system in which the abnormality has been detected, thereby remedying a fault.

### CITATION LIST

### Patent Literature

Patent Literature 1: WO 2011-099233 A1

Patent Literature 2: JP 08-063365 A

Patent Literature 3: JP 02-301836 A

### SUMMARY OF INVENTION

### Technical Problem

In Patent Literature 1, when a fault is detected, normal data is selected and output. Therefore, processing can be continued, but the fault is not remedied. Thus, there is a problem that after the fault is detected, redundancy is lost and reliability is reduced.

In Patent Literature 2, processing that has been executed cannot be continued while a fault is being remedied. Thus, there is a problem that Patent Literature 2 cannot be applied to an embedded system that requires real-time operation.

In Patent Literature 3, abnormal data at occurrence of a comparison error is not corrected to normal data, so that data that is read by the CPU at occurrence of the comparison error is received by the CPU. Thus, in order to continue processing, it is necessary, after the fault is remedied, to read data that has caused the comparison error again.

The present invention has been made to solve the above-described problems, and aims to provide a data processing device that can continue processing requiring real-time operation and can also maintain high reliability even if a fault occurs within a CPU.

### Solution to Problem

A data processing device according to one aspect of the present invention includes a memory to store a program and data; and a first CPU (Central Processing Unit) and a second CPU, each having an instruction processing section to process an instruction, a cache to store part of the program and the data of the memory, an error detection section to detect an error in the data stored in the cache and output an error notification, and an error correction section to correct the data stored in the cache on a basis of the data stored in the cache and the error notification and output corrected data to the instruction processing section, wherein the error correction section of the first CPU receives, as input, the data stored in the cache of the first CPU, the error notification output by the error detection section of the first CPU, the data stored in the cache of the second CPU, and the error notification output by the error detection section of the second CPU, and if the error notification output by the error detection section of the first CPU is an error and the error notification output by the error detection section of the second CPU is not an error, outputs the data stored in the cache of the second CPU to the instruction processing section of the first CPU, and in other cases, outputs the data stored in the cache of the first CPU to the instruction processing section of the first CPU.

### Advantageous Effects of Invention

According to the present invention, a memory to store a program and data, and a first CPU and a second CPU, each having an instruction processing section to process an instruction, a cache to store part of the program and the data of the memory, an error detection section to detect an error in the data stored in the cache and output an error notification, and an error correction section to correct the data stored in the cache on a basis of the data stored in the cache and the error notification and output corrected data to the instruction processing section, are provided. The error correction section of the first CPU receives, as input, the data stored in the cache of the first CPU, the error notification output by the error detection section of the first CPU, the data stored in the cache of the second CPU, and the error notification output by the error detection section of the second CPU, and if the error notification output by the error detection section of the first CPU is an error and the error notification output by the error detection section of the second CPU is not an error, outputs the data stored in the cache of the second CPU to the instruction processing section of the first CPU, and in other cases, outputs the data stored in the cache of the first CPU to the instruction processing section of the first CPU. Thus, even if a fault occurs within the CPU, it is possible to continue processing and maintain high reliability.

### BRIEF DESCRIPTION OF DRAWINGS

FIG. 1 is a diagram illustrating a hardware configuration in a first embodiment;

FIG. 2 is a circuit configuration diagram of an error correction section in the first embodiment;

FIG. 3 is a table indicating conditions for the error correction section to output corrected data in the first embodiment;

FIG. 4 is a flowchart of a program executed by an instruction processing section in a second embodiment; and

FIG. 5 is a flowchart of an error recovery process in the second embodiment.

### DESCRIPTION OF EMBODIMENTS

### First Embodiment

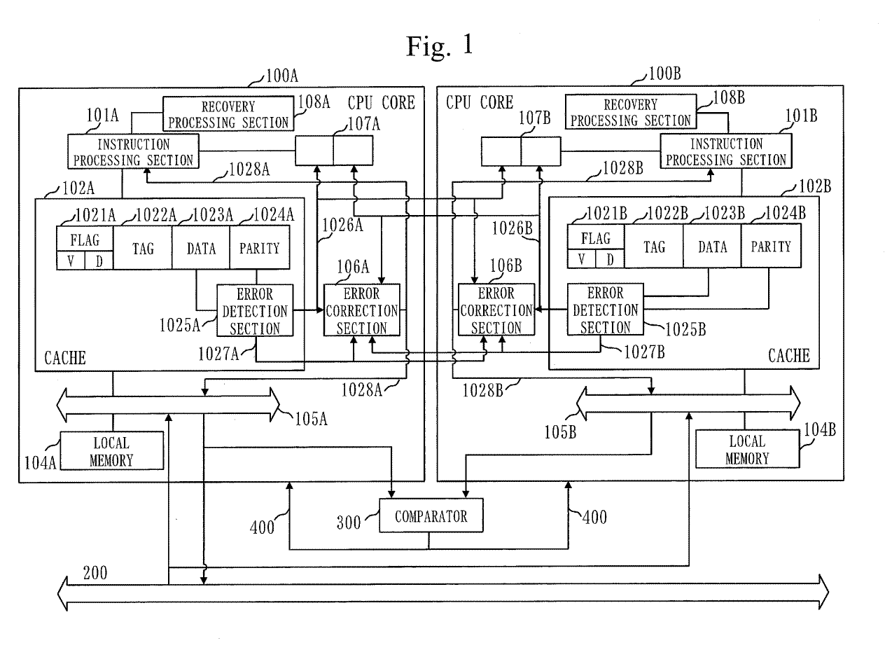

FIG. 1 is a diagram illustrating a hardware configuration of the present invention.

With reference to FIG. 1, 100A and 100B are CPUs that are identical in configuration and are connected to a system bus 200. Only the output of the CPU 100A is connected to the system bus 200. In this embodiment, the CPU 100A and the CPU 100B are identical in configuration. However, the CPU 100 A and the CPU 100B may have mutually different components, provided that components to be described in this embodiment are identical between the CPU 100 A and the CPU 100B.

A comparator 300 receives, as input, the output of the CPU 100A and the output of 100B, and outputs a result of comparing the two outputs to a comparison error signal 400.

The internal configuration of the CPU 100A will now be described. The internal configuration of the CPU 100B is the same as the internal configuration of the CPU 100A.

The CPU 100A includes an instruction processing section 101A to process an instruction, a local memory (memory) 104A to store instruction codes and data that are processed in the instruction processing section 101A, a cache 102A to temporarily store the data in the local memory 104A, a data correction section 106A to correct data if an error is detected in the cache 102A, a register 107A to store error detection signals of the CPU 100A and the CPU 100B, and a recovery processing section 108A to restore data output by the cache 102A.

The cache 102A and the local memory 104A are connected through a bus 105A. In this embodiment, the memory is the local memory 104A in the CPU 100A. However, the memory may be provided externally to the CPU 100A, and may be a memory connected to the bus 200 or an external storage device, for example.

The cache 102A includes a flag 1021A to indicate a data storage state, a tag 1022A to indicate an address of stored data, a data area 1023A to store part of the data in the local memory 104A, a parity area 1024A to store parity corresponding to the data area 1023A, and an error detection section 1025A to check whether a parity error has occurred on the basis of the data area 1023A and the parity area 1024A. In this embodiment, the error detection section 1025A is a component internal to the cache 102A. However, the error detection section 1025A may be a component external to the cache 102A and may be executed by the instruction processing section 101A, for example.

The error detection section 1025A outputs an error detection signal 1026A to indicate whether or not a parity error has occurred to the error correction section 106A and stores the error detection signal 1026A in the register 107A.

A signal value of an error detection signal 1026B output from an error detection section 1025B of the CPU 100B is also stored in the register 107A.

The error correction section 106A performs error correction by using, as input, the error detection signal 1026A of the CPU 100A, data 1027A output by the cache 102A, the error detection signal 1026B of the CPU 100B, and data 1027B output by a cache 102B of the CPU 100B.

The error correction section 106A outputs corrected data 1028A to the instruction processing section 101A and the bus 105A.

The recovery processing section 108A refers to the register 107A, and restores the data 1027A output by the cache 102A if an error is detected. In this embodiment, the recovery processing section 108A is a component internal to the CPU 100A. However, the recovery processing section 108A may be a program on the local memory 104A, or may be a program on a memory (not illustrated) connected to the bus 200 or an external storage device, for example.

The operation of the CPU 100A will now be described.

The instruction processing section 101A reads an instruction to be executed or data required for execution from the local memory 104A. At this time, a read request from the instruction processing section 101A is first transferred to the cache 102A to check whether the data to be read is stored in the data area 1023A in the cache 102A.

The cache 102A checks whether the data requested to be read is stored in the data area 1023A on the basis of information in the flag 1021A and the tag 1022A.

If the applicable data is present in the data area 1023A, the cache 102A reads the applicable data in the data area 1023A and the corresponding parity area 1024A, and inputs them to the error detection section 1025A.

If no applicable data is present in the data area 1023A and the same data as the data in the local memory 104A is stored in an area for storing the applicable data (if a Dirty bit (D) in the flag 1021A is 0), the cache 102A invalidates the area for storing the applicable data, then requests a read from the local memory 104A via the bus 105A, and reads data that is of a size storable in the cache 102A.

The cache 102A stores the data that has been read from the local memory 104A in the data area 1023A, and updates the flag 1021A and the tag 1022A.

The cache 102A creates parity corresponding to the value of the data and stores the parity in the parity area 1024A.

The cache 102A outputs the stored data and parity to the error detection section 1025A.

The error detection section 1025A tests whether there is a match between the input data and parity.

If the parity is not a match, the error detection section 1025A outputs “1” (error present) to the error detection signal 1026A.

If there is a match between the data and the parity, the error detection section 1025A outputs “0” (no error) to the error detection signal 1026A.

The cache 102A outputs the error detection signal 1026A to the error correction section 106A and the register 107A and also to an error correction section 106B and a register 107B of the other CPU 100B.

The cache 102A outputs the data 1027A requested by the instruction processing section 101A to be read, to the error detection section 106A and also to the error correction section 106B of the other CPU 100B.

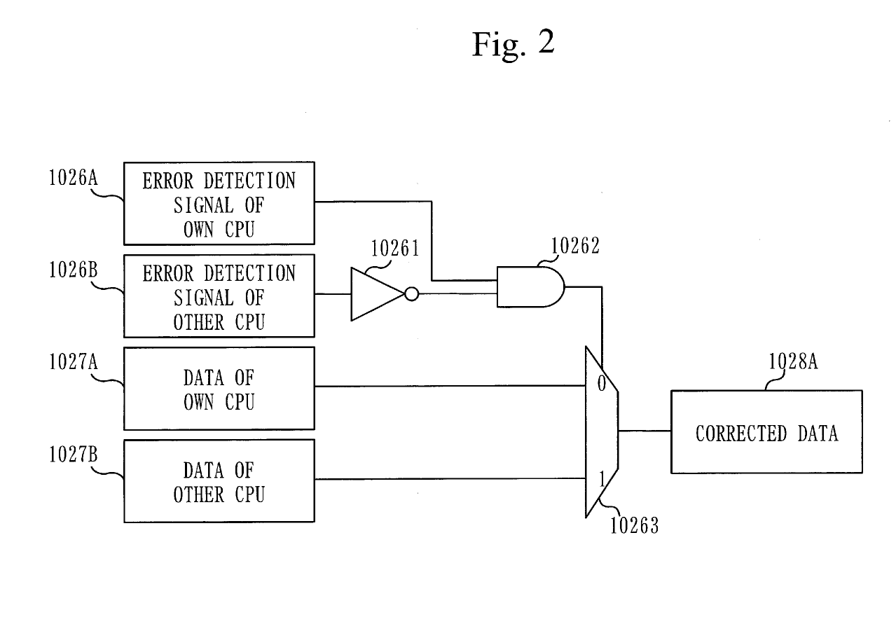

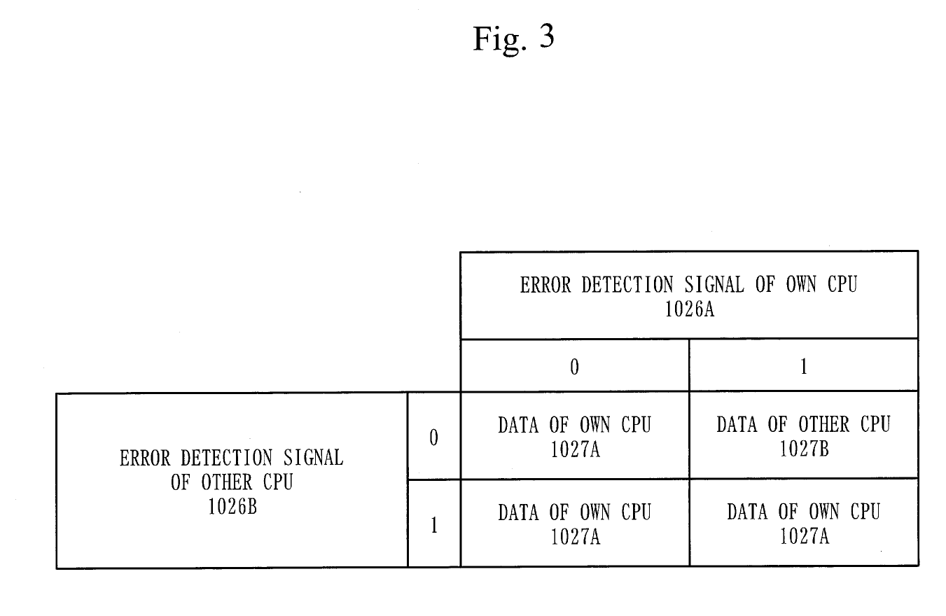

With reference to FIG. 2 and FIG. 3, the error correction section 106A will be described in detail.

FIG. 2 is a circuit configuration of the error correction section 106A, and FIG. 3 is a table indicating conditions for outputting the corrected data 1028A.

In FIG. 2, 10261 represents a NOT gate, 10262 represents an AND gate, and 10263 represents a selector.

If the output of the AND gate 10262 is 0, the selector 10263 outputs the data 1027A of the CPU 100A which is its own CPU. If the output of the AND gate 10262 is 1, the selector 10263 outputs the data 1027B of the CPU 100B which is the other (another) CPU. The output data is output to the instruction processing section 101A as the corrected data 1028A.

If no applicable data is present in the data area 1023A and data that is more recent than the data in the local memory 104A is stored in the area for storing the applicable data (if the Dirty bit (D) in the flag 1021A is 1), the cache 102A writes the data in the area for storing the applicable data to the local memory 104A.

The cache 102A reads the data to be written to the local memory 104A from the data area 1023A and the parity 1024A, and outputs the data and the parity that have been read to the error detection section 1025A.

The error detection section 1025A tests whether there is a match between the input data and parity.

If the parity is not a match, the error detection section 1025A outputs “1” (error present) to the error detection signal 1026A.

If there is a match between the data and the parity, the error detection section 1025A outputs “0” (no error) to the error detection signal 1026A.

The cache 102A outputs the error detection signal 1026A to the error correction section 106A and also to the error correction section 106B of the other CPU 100B. The cache 102A outputs the data 1027A to be written to the local memory 104A to the error correction section 106B.

The error correction section 106A performs correction by using, as input, the error detection signal 1026A and the data 1027A that are output from the cache 102A and also the error detection signal 1026B and the data 1027B that are output from the cache 102B of the CPU 100B.

The error correction section 106A outputs the corrected data 1028A to the local memory 104A via the bus 105A. After writing to the local memory 104A by the above-described operation, the error correction section 106A requests a read from the local memory 104A and reads data that is of a size storable in the cache 102A.

The cache 102A stores the data that has been read from the local memory 104A in the data area 1023A, and updates the flag 1021A and the tag 1022A.

The cache 102A creates parity corresponding to the value of the data, and stores the parity in the parity area 1024A.

The cache 102A outputs the stored data and parity to the error detection section 1025A.

The error detection section 1025A tests whether there is a match between the input data and parity.

If the parity is not a match, the error detection section 1025A outputs “1” (error present) to the error detection signal 1026A.

If there is a match between the data and the parity, the error detection section 1025A outputs “0” (no error) to the error detection signal 1026A.

The cache 102A outputs the error detection signal 1026A to the error correction section 106A and the register 107A and also to the error correction section 106B and the register 107B of the other CPU 100B.

The cache 102A outputs to the error correction section 106B the data 1027A requested by the instruction processing section 101A to be read.

The error correction section 106A performs correction by using, as input, the error detection signal 1026A and the data 1027A that are output from the cache 102A and also the error detection signal 1026B and the data 1027B that are output from the cache 102B of the CPU 100B.

The error correction section 106A outputs the corrected data 1028A.

If the error detection signal 1026A output by the cache 102A of the CPU 100A of the error correction section 106A itself is “0”, no error has occurred. Thus, the error correction section 106A outputs the value of the data 1027A as the corrected data 1028A.

If the error detection signal 1026A and the error detection signal 1026B are both “1”, errors have occurred in both of the CPU 100A and the CPU 100B. Thus, neither piece of data is correct, so that the error correction section 106A outputs the value of the data 1027A of the CPU 100A of the error correction section 106A itself as the corrected data 1028A.

On the other hand, if the error detection signal 1026A is “1” and the error detection signal 1026B is “0”, this signifies that an error has occurred in the CPU 100A and no error has occurred in the CPU 100B.

Therefore, it is deduced that the data 1027A is an abnormal value and the data 1027B is a normal value, so that the value of the data 1027B is output as the corrected data 1028A.

The register 107A stores both the value of the error detection signal 1026A output from the cache 102A and the value of the error detection signal 1026B output from the cache 102B of the CPU 100B.

If each signal outputs 1, that value is retained. When reading the value of the register 107A, the recovery processing section 108A can check whether an error has occurred.

The error correction section 106A outputs the corrected data 1028A to the instruction processing section 101A.

The instruction processing section 101A continues processing on the basis of the data output by the error correction section 106A.

The operation of the CPU 100A has been described above. The operation of the CPU 100B is the same as the operation of the CPU 100A.

Effects of this embodiment will be described.

Conventionally, if an error occurs where one bit is inverted in the value in the data area 1023A of the cache 102A of the CPU 100A, the error detection section 1025A detects a parity error but cannot correct the data. Thus, the instruction processing section 101A that has read the data cannot receive the correct value, and it is difficult to continue normal operation. In this embodiment, as described above, the error correction section 106A outputs the data 1027B in the CPU 100B where no error has occurred to the instruction processing section 101A as the corrected data 1028A. Thus, the instruction processing section 101A receives the normal data, and can continue processing in the same way as if no error has occurred.

### Second Embodiment

This embodiment describes a recovery process for the cache in an area containing data where an error has occurred.

This embodiment describes an example in which processes 1 to 3 are executed repeatedly as regular processes. It is assumed that priority levels of the processes 1, 2, and 3 are 100, 200, and 300, respectively, and that the lower the number, the higher the priority level.

It is also assumed that the process 1 is a process that is essential for the operation of the system, and the processes 2 and 3 are additional processes for realizing enhanced functionality of the system. Therefore, when a malfunction occurs, the system can continue operating if the process 1 can be continued, albeit with restricted functionality.

The process 1, the process 2, and the process 3 may be a program on the local memory 104A, or may be a program on a memory (not illustrated) connected to the bus 200 or an external storage device.

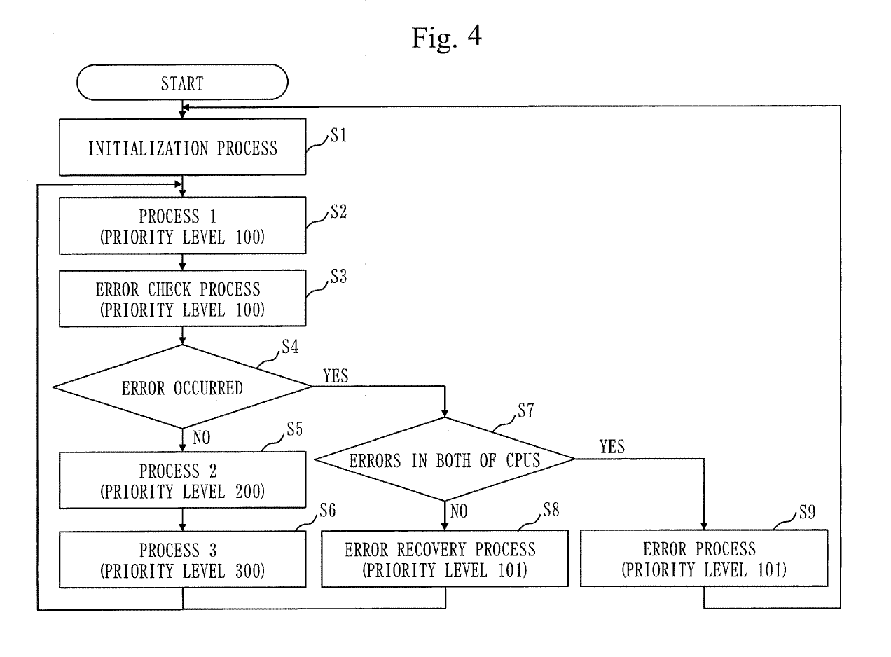

FIG. 4 illustrates a flowchart of a program executed by the instruction processing section 101A in this embodiment.

The operation of the flowchart of FIG. 4 will be described.

When the CPU is reset and processing is started, an initialization process is executed first (S1). In the initialization process, the memory and IO are initialized and an error check for the hardware is performed.

Upon completion of the initialization process, the process 1 is executed (S2).

Following completion of the execution of the process 1, an error check process is performed (S3).

In the error check process, the value of the error detection signal 1026A of the CPU 100A and the value of the error detection signal 1026B of the CPU 100B that are stored in the register 107A are read.

At this time, if the value of the error detection signal 1026A and the value of the error detection signal 1026B are both “0” and thus no error has occurred (if the condition of S4 is determined as NO), the process 2 is executed (S5) and then the process 3 is executed (S6).

Upon completion of the execution of the process 3, the process 1 is executed again (returning to S2).

On the other hand, if one or both of the value of the error detection signal 1026A and the value of the error detection signal 1026B is “1” and thus an error has occurred (if the condition of S4 is determined as YES), it is checked whether errors have occurred in both of the CPUs (S7).

If errors have occurred in both of the CPUs (if the condition of S7 is determined as YES), an error process is performed (S9).

In the error process, the error process to handle occurrence of a parity error in the cache 102A is performed. It is described herein that the CPU is reset and then the initialization process (S1) and the subsequent processes are performed again. However, an error process to handle occurrence of an error defined in the system may be performed.

If an error has occurred in only one of the CPU 100A and the CPU 100B, that is, if only one of the error detection signals 1026A and 1026B is “1” and the other one is “0” (if the condition of S7 is determined as NO), the recovery processing section 108A performs an error recovery process (S8).

Upon completion of the error recovery process, the process 1 is executed again (returning to S2).

In this embodiment, as illustrated in the flowchart of FIG. 4, if only one of the error detection section 1025A and the error detection section 1025B detects an error, the instruction processing section 101A executes only the process 1 (S2) and the error recovery process (S8) without executing the process 2 (S5) and the process 3 (S6). In an embedded system with time constrains, there is a process that needs to be executed within a specified time, and if the execution of the process is not completed, this may cause the system to stop. Therefore, if only the error recovery process (S8) is executed upon detection of an error, the system being executed by the CPU 100A will be caused to stop.

If there is not enough time to execute any other process than the process 1, the process 2, and the process 3, the error recovery process (S8) cannot be executed. However, when it is assumed that the process 1 is a process that is essential for the operation of the system and the processes 2 and 3 are additional processes for realizing enhanced functionality of the system, as described above, the system can continue operating if at least the execution of the process 1 can be continued. According to the present invention, only the process 1 that is essential for the operation of the system is executed upon detection of an error, so as to secure the time to execute the error recovery process (S8). Thus, it is possible to realize the continuation of the operation of the system and enhanced reliability.

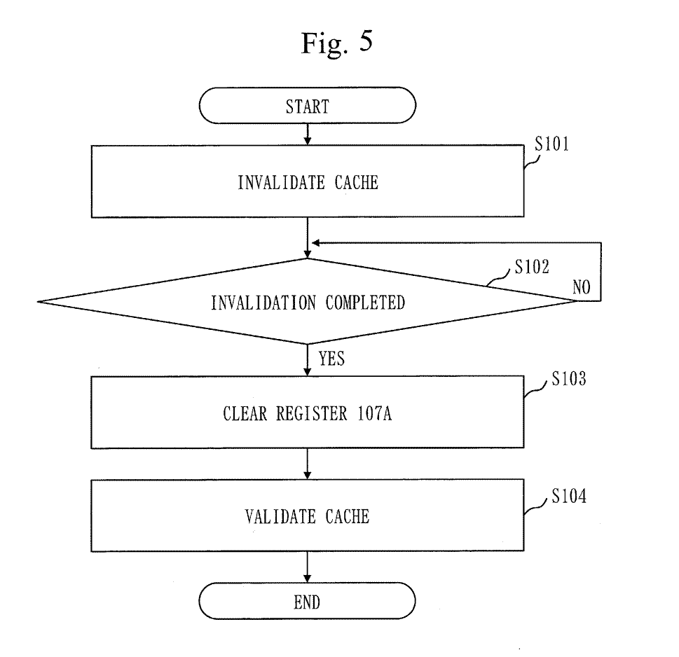

With reference to the flowchart of FIG. 5, the error recovery process (S8) will now be described.

In the error recovery process, an instruction to invalidate the cache in the area containing the data where the error has occurred is issued to the cache 102A first

(S101).

Then, completion of invalidation of the cache is waited for (repeated while NO in S102). Upon completion of the invalidation (YES in S102), the value of the register 107A is cleared (S103). When the value of the register 107A is cleared, 0 may be set, for example.

Then, an instruction to validate the cache again is issued to the cache 102A (S104).

The operation of the cache 102A when the cache 102A is invalidated in S101 is the same as conventional cache invalidation operation.

Upon receiving the instruction to invalidate the cache by a program, the cache 102A sets a Valid bit (V), in the flag 1021A, to indicate the storage state to 0 (invalid) and discards the content.

When the cache 102A is a write-through cache, the same value as the data stored in the cache is also stored in the local memory 104A, so that the Valid bit (V) in the flag 1021A may only be set to 0.

However, when the cache 102A is a write-back cache, occurrence of a write from the instruction processing section 101A to the local memory 104A causes the write to be performed to the data area 1023A in the cache 102A, but the write is not performed to the local memory 104A.

Therefore, it may be necessary to write the most recent value stored in the data area 1023A at the time when the cache 102A is invalidated to the local memory 104A.

Whether the most recent value is stored in the local memory 104A or is written in the data in the cache 102A is determined depending on whether the Dirty bit (D) in the flag 1021A is 1.

If the Dirty bit is 0, the value stored in the data area 1023A is the same as the value stored in the local memory 104A, so that the cache 102A sets the Valid bit in the flag 1021A to 0.

If the Dirty bit is 1, the value stored in the data area 1023A is different from the value stored in the local memory 104A, so that the cache 102A reads the parity in the corresponding parity area 1024A together with the data in the data area 1023A. After a parity check is performed in the error detection section 1025A, the cache 102A outputs the error detection signal 1026A and the data 1027A to the error correction section 106A.

The error correction section 106A performs error correction by using, as input, the error detection signal 1026A and the data 1027A that have been output by the cache 102A.

At this time, the CPU 100B has performed the same operation, so that the value of the error detection signal 1026B and the value of the data 1027B are also input to the error correction section 106A.

The error correction section 106A performs correction by using, as input, the error detection signal 1026A and the data 1027A that have been output from the cache 102A and also the error detection signal 1026B and the data 1027B that have been output from the cache 102B of the CPU 100B. The corrected data 1028A is output (written) to the local memory 104A via the bus 105A.

As described above, if the Dirty bit is 1, the error correction section 106A writes the data stored in the data area 1023A to the local memory 104A, and then sets both the Dirty bit and the Valid bit to 0.

Effects of this embodiment will be described.

Conventionally, in a state in which an error of an inverted bit as described above occurs and remains uncorrected, when the instruction processing section 101A reads the data, the error correction section 106A will always output the data 1027B in the CPU 101B as the corrected data 1028A.

Therefore, if in this state another error occurs where a bit is inverted in the data area 1023B of the CPU 101B, error correction cannot be performed, resulting in reduced reliability.

In this embodiment, when the error detection section 1025A detects an error, the program being executed by the instruction processing section 101A performs the error recovery process (S8) to attempt to recover from the error of the inverted bit in the data area 1023A.

With this, when the error of the inverted bit in the data area 1023A is a temporary error, such as a software error, the data can be restored by writing the value again from the local memory 104A to the data area 1023A.

For this reason, in the error recovery process (S8) of the program, the instruction processing section 101A writes the value of the local memory 104A to the data area 1023A by invalidating the cache 102A once and then validating it again. Thus, a state with high reliability can be restored after occurrence of the error.

When the error is not a temporary error, the error detection section 1025A will detect the error again after the data is restored. However, the error correction section 106A outputs the data 1027B in the CPU 101B to the instruction processing section 101A as the corrected data 1028A. Thus, the instruction processing section 101A can receive the normal data and continue processing, albeit with reduced reliability as a result of operating with only one system of the CPU 101B.

In this embodiment, a process to return the correct value when a read is requested by the instruction processing section 101A and a process to return the correct value to the local memory 104A when the cache is invalidated are both performed with the same hardware (the error correction section 106A).

As illustrated in FIG. 2, the error correction section 106A is configured with only a selector to output either of the data 1027A of its own CPU 100A and the data 1027B of the other CPU 100B as the corrected data 1028A and a logic circuit to determine which piece of data is selected on the basis of the value of the error detection signal 1026A and the value of the error detection signal 1026B, so that the amount of hardware is small.

According to the present invention, error correction when an error has occurred and recovery from the error state can thus be realized with a small amount of hardware.

### REFERENCE SIGNS LIST

100A: CPU core, 100B: CPU core, 101A: instruction processing section, 101B: instruction processing section, 102A: cache, 102B: cache, 104A: local memory, 104B: local memory, 105A: bus, 105B: bus, 106A: error correction section, 106B: error correction section, 107A: register, 107B: register, 108A: recovery processing section, 108B: recovery processing section, 200: bus, 300: comparator, 400: comparison error signal, 1021A: flag, 1021B: flag, 1022A: tag, 1022B: tag, 1023A: data, 1023B: data, 1024A: parity, 1024B: parity, 1025A: error detection section, 1025B: error detection section, 1026A: error detection signal, 1026B: error detection signal, 1027A: data output by the cache 102A, 1027B: data output by the cache 102B, 1028A: corrected data, 1028B: corrected data

1-2. (canceled)

3. A data processing device comprising:
a memory to store a program and data; and
a first CPU (Central Processing Unit) and a second CPU, each having an instruction processing section to process an instruction, a cache to store part of the program and the data of the memory, an error detection section to detect an error in the data stored in the cache and output an error notification, and an error correction section to correct the data stored in the cache on a basis of the data stored in the cache and the error notification and output corrected data to the instruction processing section, the first CPU and the second CPU performing same operation,
wherein the error correction section of the first CPU receives, as input, the data stored in the cache of the first CPU, the error notification output by the error detection section of the first CPU, the data stored in the cache of the second CPU, and the error notification output by the error detection section of the second CPU, and in a case of first error detection in which the error notification output by the error detection section of the first CPU is an error and the error notification output by the error detection section of the second CPU is not an error, outputs the data stored in the cache of the second CPU to the instruction processing section of the first CPU, and in a case other than the first error detection, outputs the data stored in the cache of the first CPU to the instruction processing section of the first CPU,
wherein the first CPU further includes a first register to store the error notification output by the error correction section of the first CPU and the error notification output by the error correction section of the second CPU, and a recovery processing section to refer to the first register and restore the cache of the first CPU if one of the stored error notifications is an error,
wherein the second CPU further includes a second register to store the error notification output by the error correction section of the first CPU and the error notification output by the error correction section of the second CPU, and a recovery processing section to refer to the second register and restore the cache of the second CPU if one of the stored error notifications is an error, and
wherein the instruction processing section of the first CPU executes a first process, refers to the first register upon completion of execution of the first process, executes a second process if neither of the error notifications stored in the first register is an error, executes an error process without executing the second process if both of the error notifications stored in the first register are errors, and causes the recovery processing section of the first CPU to restore the cache of the first CPU without executing the second process if one of the error notifications stored in the first register is an error.

4. The data processing device according to claim 3,
wherein a cache restoration process performed by the first CPU and the second CPU is a process to invalidate the cache and then validate the cache again.
